(19) United States
(12) Patent Application Publication
(10) Pub. No.: US 2026/0067175 A1
(43) Pub. Date: Mar. 5, 2026

(54) APPARATUSES AND COMMUNICATION METHODS FOR AI/ ML OPERATION

(71) Applicant: GUANGDONG OPPO MOBILE TELECOMMUNICATIONS CORP., LTD., Dongguan (CN)

(72) Inventors: Alla GOLDNER, Tel Aviv (IL); Jingran CHEN, Dongguan (CN); Yang XU, Dongguan (CN)

(21) Appl. No.: 19/379,985

(22) Filed: Nov. 5, 2025

Related U.S. Application Data
(63) Continuation of application No. PCT/CN2023/108952, filed on Jul. 24, 2023.

(51) Int. Cl. H04L 41/16; H04L 12/14

(52) U.S. Cl. CPC H04L 41/16; H04L 12/14

(57) ABSTRACT

A communication method for artificial intelligence (AI)/machine learning (ML) operation includes transmitting, by a network exposure function (NEF) to a charging function (CHF), a charging data request message comprising at least one information element associated with a charging reporting for AI/ML operation and allowing and/or triggering the CHF to identify the at least one information element associated with the charging reporting for AI/ML operation based on the charging data request message.

### CROSS-REFERENCE TO RELATED APPLICATION

This application is a Continuation Application of International Application No. PCT/CN2023/108952 filed Jul. 24, 2023, which is incorporated herein by reference in its entirety.

### TECHNICAL FIELD

The present disclosure relates to the field of communication systems, and more particularly, to apparatuses and communication methods for artificial intelligence (AI)/machine learning (ML) operation such as network exposure function (NEF) initiated charging reporting for AI/ML operation.

### BACKGROUND

There is currently standardization activity in 3rd generation partnership project (3GPP) work studying artificial intelligence/machine learning (AI/ML) functionality. However, in current technologies, charging aspects for artificial intelligence (AI)/machine learning (ML) have not been identified in a 5G core network (5GC).

Therefore, there is a need for apparatuses and communication methods for artificial intelligence (AI)/machine learning (ML) operation such as network exposure function (NEF) initiated charging reporting for AI/ML operation, which can address these and other issues.

### SUMMARY

In a first aspect of the present disclosure, a communication method for artificial intelligence (AI)/machine learning (ML) operation includes transmitting, by a network exposure function (NEF) to a charging function (CHF), a charging data request message including at least one information element associated with a charging reporting for AI/ML operation and allowing and/or triggering the CHF to identify the at least one information element associated with the charging reporting for AI/ML operation based on the charging data request message.

In a second aspect of the present disclosure, a communication device includes a transmitter and a triggering unit. The transmitter is configured to transmit to a charging function (CHF), a charging data request message including at least one information element associated with a charging reporting for artificial intelligence (AI)/machine learning (ML) operation. The triggering unit is configured to configured to allow and/or trigger the CHF to identify the at least one information element associated with the charging reporting for AI/ML operation based on the charging data request message.

In a third aspect of the present disclosure, a network device includes a memory, a transceiver, and a processor coupled to the memory and the transceiver. The network device is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of non-roaming 5G system architecture configured to implement some embodiments presented herein.

FIG. 2 is a block diagram of a northbound API converged charging architecture non-roaming reference point representation configured to implement some embodiments presented herein.

FIG. 3 is a block diagram of a network device according to an embodiment of the present disclosure.

FIG. 4 is a flowchart illustrating a communication method for artificial intelligence (AI)/machine learning (ML) operation according to an embodiment of the present disclosure.

FIG. 5 is a block diagram of a communication device according to an embodiment of the present disclosure.

FIG. 6 is a flowchart illustrating an API Invocation Request to NEF using IEC configured to implement some embodiments presented herein.

FIG. 7 is a flowchart illustrating an API Invocation Request to NEF using ECUR configured to implement some embodiments presented herein.

FIG. 8 is a flowchart illustrating an API Notification from NEF using IEC configured to implement some embodiments presented herein.

FIG. 9 is a flowchart illustrating an API Notification from NEF using ECUR configured to implement some embodiments presented herein.

FIG. 10 is a flowchart illustrating an API Invocation Request to NEF using PEC configured to implement some embodiments presented herein.

FIG. 11 is a flowchart illustrating an API Notification from NEF using PEC configured to implement some embodiments presented herein.

FIG. 12 is a block diagram of an example of a computing device according to an embodiment of the present disclosure.

FIG. 13 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

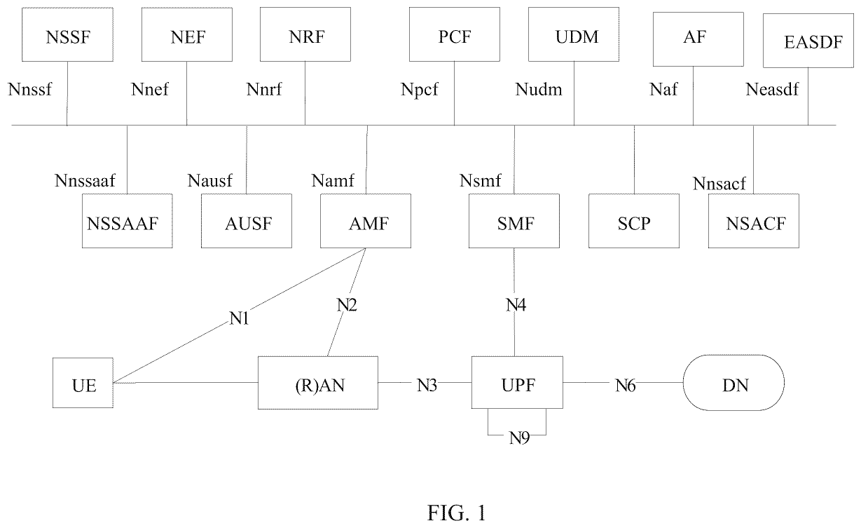

FIG. 1 illustrates a non-roaming 5G system architecture configured to implement some embodiments presented herein. In the 5G non-roaming system architecture, network functions communicate with each other over a service-based interface in a core network (CN). A user equipment (UE) may communicate with the core network to establish control signaling and enable the UE to use services from the CN. Examples of control signaling functions are registration, connection and mobility management, authentication and authorization, session management, etc. After control signaling have been established, the UE can then utilize the user plane functionality to send and receive data to and from a Data Network (DN), e.g., the internet.

The 5G System architecture includes the following network functions (NF): Authentication Server Function (AUSF), Access and Mobility Management Function (AMF), Data Network (DN), e.g., operator services, Internet access or 3rd party services, Unstructured Data Storage Function (UDSF), Network Exposure Function (NEF), Network Repository Function (NRF), Network Slice Admission Control Function (NSACF), Network Slice-specific and SNPN Authentication and Authorization Function (NSSAAF), Network Slice Selection Function (NSSF), Policy Control Function (PCF), Session Management Function (SMF), Unified Data Management (UDM), Unified Data Repository (UDR), User Plane Function (UPF), UE radio Capability Management Function (UCMF), Application Function (AF), User Equipment (UE), (Radio) Access Network ((R)AN), 5G-Equipment Identity Register (5G-EIR), Network Data Analytics Function (NWDAF), CHarging Function (CHF), Time Sensitive Networking AF (TSN AF), Time Sensitive Communication and Time Synchronization Function (TSCTSF), Data Collection Coordination Function (DCCF), Analytics Data Repository Function (ADRF), Messaging Framework Adaptor Function (MFAF), and Non-Seamless WLAN Offload Function (NSWOF).

The following descriptions highlight some of the capabilities of the network functions (NFs) from FIG. 1 that are involved with control signaling.

Access and Mobility Function (AMF): The UE sends an NI message through the RAN node to the AMF to perform control plane signaling such as registration, connection management, mobility management, access authentication and authorization, etc.

Session Management Function (SMF): The SMF is responsible for session management involved with establishing PDU sessions to allow UEs to send data to Data Networks (DNs) such as the internet or to an application server and other session management related functions.

Policy and Control Function (PCF): The PCF provides the policy framework that governs network behavior, accesses subscription information to make policy decisions, etc.

Authentication Server Function (AUSF): The AUSF supports authentication of UEs for 3GPP and untrusted non-3GPP accesses.

Unified Data Management/Repository (UDM/UDR): The UDM/UDR supports generation of 3GPP AKA Authentication Credentials, user identification handling, subscription management and storage, etc. [0009] Network Slice Selection Function (NSSF): The NSSF is involved with aspects of network slice management such as selection of network slice instances for UEs, management of NSSAIs, etc.

Network Repository Function (NRF): The NRF supports service discovery function in the 5G network.

Network Exposure Function (NEF): The NEF supports the exposure of capabilities and events in the core network to third parties, Application Functions (AF), Edge Computing, etc.

The RAN node offers communication access from the UE to the core network for both control plane and user plane communications. A UE establishes a PDU session with the CN to send data traffic over the user plane through the (R)AN and UPF nodes of the 5G system (5GS). Uplink traffic is sent by the UE and downlink traffic is received by the UE using the established PDU session. Data traffic flows between the UE and the DN through the intermediary nodes: (R)AN and UPF.

AI/ML functionality is introduced in Release 18 3GPP work. The related enhancements are introduced into 5GC functionality, specifically for the negotiation between AF and NEF, NEF and PCF, including identification of the traffic related to AI/ML usage and also monitoring and handling of lists of UEs, including consolidated data rate of those UEs. In order to decide which UEs are appropriate for AI/ML operation. However, charging aspects for AI/ML have not been identified, and some embodiments of the present disclosure propose to include functionality related to the charging reporting from the 5GC to CHF (charging function).

The 3GPP documents which define the existing technology are TS32.290 and TS 32.254. TS 32.290 defines services, operations and procedures of charging using Service Based Interface (SBI). Among the procedures, it defines triggers, based on which, charging reporting should be re-initiated by the core network (5GC) in the direction of CHF. In some embodiments of the present disclosure, the list of the triggers would need to be extended in order to support AI/ML charging reporting operation. TS 32.254 defines exposure function northbound Application Program Interfaces (APIs) charging. As some embodiments of the present disclosure are about extending 5GC NEF's network exposure function charging reporting. Some embodiments of the present disclosure would need to be extended to include NEF charging reporting support for the newly suggested parameters related to AI/ML operation.

As stated in the TS 23.501: “At the time or during the AI/ML operation. e.g., Federated Learning, the AF may request the serving NEF to provide QoS for a list of UEs, each UE identified by its UE IP address. The AF may subscribe to QoS Monitoring which may include also Consolidated Data Rate monitoring as described in clause 5.45 and in clause 4.15.6.13 of TS 23.502 [3] for those AF requests for QoS that result in a successful resource allocation. The AF provides QoS parameters that are derived from the performance requirements listed in clause 7.10 of TS 22.261.” Furthermore, TS 23.502, clause 4.15.6.13 Multi-member AF session with required QoS defines the procedures for such QoS monitoring. TS 32.254 defines how NEF based charging reporting can be done once NEF is triggered by a new service request received from AF. Some embodiments of the present disclosure propose to include functionality related to the charging reporting from the 5GC to CHF (charging function).

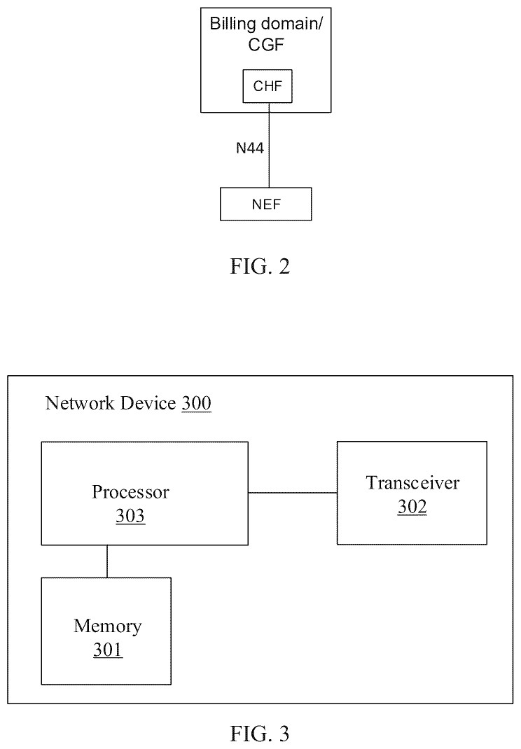

FIG. 2 illustrates a northbound API converged charging architecture non-roaming reference point representation configured to implement some embodiments presented herein. Referring to FIG. 2, N44 may be a reference point between the NEF and the CHF. For northbound API invocation/notification, the NEF collects the following charging information: Invocations/notifications count of the northbound APIs, Identification of the SCS/AS or AF and the associated northbound API invocation/notification, Timestamp of the northbound API invocation/notification, and Northbound API related information, e.g., location. It is understood that northbound API is applicable here for the NEF-AF communication. The Northbound APIs supported by the NEF via the set of exposed services defined in 3GPP TS 23.502 are covered for converged charging reporting. Thus, the addition of Consolidated Data Rate monitoring for a list of UEs, introduced for a purpose of e.g., AI/ML Federated Learning operation, needs also be supported, and this is regarding some embodiments of the present disclosure.

As per TS 32.254, “converged charging may be performed by the NEF interacting with CHF using Nchf specified in TS 32.290 and TS 32.291. In order to provide the data required for the management activities outlined in TS 32.240 (Credit-Control, accounting, billing, statistics etc.), the NEF shall be able to perform converged charging for the northbound API access. The NEF shall be able to perform convergent charging by interacting with CHF, for charging data related to Northbound API access. The Charging Data Request and Charging Data Response are exchanged between the NEF and the CHF, based on PEC, either IEC or ECUR scenarios specified in TS 32.290. The Charging Data Request is issued by the NEF towards the CHF when certain conditions (chargeable events) are met. The selection of the CHF can be configured in the NEF but may also rely on NRF.” Applicable Triggers in the NEF in some embodiments of the present disclosure can refer to the TS 32.254, clause 5.4.1.2. The NEF converged charging messages (i.e., Charging Data Request and Charging Data Response) in some embodiments of the present disclosure can refer to the TS 32.254, clause 6.2a. 1.1. The Charging Data Request and Charging Data Response messages structure in some embodiments of the present disclosure can refer to the TS 32.254, clauses 6.2a. 1.2.1 and 6.2a. 1.2.2.

Some solutions of the present disclosure propose to include functionality related to the charging reporting from the 5GC to CHF (charging function).

### Solution 1:

In order to support an operation of Consolidated Data Rate monitoring for a list of UEs and the corresponding reporting from NEF to CHF in case list of UEs changes or Consolidated Data rate changes, as requested by the AF (e.g. supporting AI/ML Federated Learning operation or any other AI/ML related operation), new triggers, which are part of Charging Data Request message, some embodiments of the present disclosure are extended to include at least one improvement for the TS 32.254, clause 6.2a. 1.2.1:

Update the list of UEs.

Update the Consolidated Data Rate value.

The detailed Trigger definition in some embodiments of the present disclosure is extended to include at least one improvement for the TS 32.290, clause 5.4.2.

In some embodiments of the present disclosure, these new triggers may allow/trigger report from NEF to CHF once either list of requested UEs changes or Consolidated Data Rate, received in the updated request from AF to NEF, changes.

### Solution 2:

In order to support an operation of Consolidated Data Rate monitoring for a list of UEs and the corresponding reporting from NEF to CHF, “NEF API Charging Information” may be extended in some embodiments to include list of UEs identifiers as well as Consolidated Data Rate. “NEF API Charging Information” is transferred within Charging Data Request by NEF to CHF and allows CHF to know those parameters thus be able to perform billing, statistics etc.

It is noted that the Consolidated Data Rate threshold defines the upper bound of the aggregated data rate across all traffic flows corresponding to the list of UE IP addresses as some embodiments of the present disclosure extended to include at least one improvement for the TS 23.502. The Consolidated Data Rate may not be enforced in the network; however, an operator may apply offline CDRs processing for the e.g., billing, statistics etc. in the engagement with e.g., AI/ML service provider.

The text below is some embodiments of the present disclosure extended to include at least one improvement for TS 32.254 which defines how the newly introduced charging parameters might be embedded into the specification.

### EXAMPLES

### Example 1

### 6.2a.1.2.1 Charging Data Request Message

Table 6.2a.1.2.1.1 illustrates the basic structure of a Charging Data Request message as used for NEF converged charging.

TABLE 6.2a.1.2.1.1
Charging Data Request message contents

| Information Element | Category | Description |
|---|---|---|
| Session Identifier | O_{C} | Described in TS 32.290 [57] |
| Subscriber Identifier | O_{M} | Described in TS 32.290 [57], |
| | | and holds the identifier of the AF |
| NF Consumer | M | Described in TS 32.290 [57] |
| Identification | | |
| Charging Identifier | O_{M} | Described in TS 32.290 [57] |
| Invocation Timestamp | M | Described in TS 32.290 [57] |
| Invocation Sequence | M | Described in TS 32.290 [57] |
| Number | | |
| Retransmission | — | This field is not applicable. |
| Indicator | | |
| One-time Event | O_{C} | Described in TS 32.290 [57]. |
| One-time Event Type | O_{C} | Described in TS 32.290 [57]. |
| Notify URI | — | This field is only applicable for |
| | | the notification of about charging. |
| Supported Features | O_{C} | Described in TS 32.290 [57] |
| Triggers | O_{C} | This field is described in TS 32.290 |
| | | [57] and holds the NEF specific |
| | | triggers described in clause 5.4 |
| Multiple Unit Usage | O_{C} | This field contains the parameters |
| | | for the quota management request |
| | | and/or usage reporting. |
| Rating Group | M | Described in TS 32.290 [57] |
| Requested Unit | O_{C} | Described in TS 32.290 [57] |
| Used Unit Container | O_{C} | Described in TS 32.290 [57] |
| NEF API Charging | O_{M} | This field holds the NEF API |
| Information | | specific information described in |
| | | clause 6.3.1.4 |

### Example 2

### 6.3.1.4 Definition of the NEF API Information

### 6.3.1.4.1 Definition of the NEF API Charging Information

Network Exposure Function API specific charging information is provided within the NEF API Charging Information. The detailed structure of the NEF API Charging Information can be found in table 6.3.1.4.1.

TABLE 6.3.1.4.1
Structure of the NEF API Charging Information

| Information Element | Category | Description |
|---|---|---|
| External Individual Identifier | O_{C} | This parameter holds the external Identifier of the |
| | | individual UE, e.g., the GPSI. |
| Internal Individual Identifier | O_{C} | This parameter holds the internal Identifier of the |
| | | individual UE e.g., the SUPI. |
| External Group Identifier | O_{C} | This parameter holds the external identifier for a |
| | | group of individual UE(s), if available. |
| Internal Group Identifier | O_{C} | The internal Identifier identifying a group of |
| | | individual UE(s). |
| List of UEs | O_{C} | This field holds the list of GPSIs or SUPIs for the |
| | | reported UEs |
| Consolidated Data Rate | O_{C} | The upper bound of the aggregated data rate across |
| | | all traffic flows corresponding to the “List of UEs” |
| API Direction | M | This field holds the direction to indicate if it is an |
| | | API invocation from an AF or notification to an AF. |
| API Target Network Function | O_{C} | This field holds the identifier of the network |
| | | function that either is the destination of the API |
| | | invocation or triggers the notification. |
| API Result Code | O_{C} | This parameter holds the result of API Invocation. |
| API Name | M | This field holds the name of the API invoked. |
| API Operation | O_{C} | This field holds the operation of the API invoked, |
| | | together with detailed description. |
| API Reference | O_{C} | This field holds the reference to the definition of the |
| | | format of the API invocation, this can be a URI or |
| | | refence to the standard where it's specified |
| API Content | O_{C} | This field holds the actual content of the API |
| | | invocation, in the format described by the API |
| | | Reference |

### Example 3

### 6.3.4 Detailed Message Format for Converged Charging

The operation types are listed in the following order: I (Initial)/U (Update)/T (Termination)/E (Event). Therefore, when all operation types are possible it is marked as IUTE. If only some operation types are allowed for a node, only the appropriate letters are used (e.g., IUT or E) as indicated in the table heading. The omission of an operation type for a particular field is marked with “-” (e.g., I-E). Also, when an entire field is not allowed in a node the entire cell is marked as “-”.

Table 6.3.4.1 illustrates the basic structure of the supported fields in the Charging Data Request for exposure function API online charging.

TABLE 6.3.4.1
Supported fields in Charging Data Request message

| | Node Type |
|---|---|
| | NEF |
| | Supported Operation Types |
| Information Element | IUTE |
| Session Identifier | I-TE |
| Subscriber Identifier | I-TE |
| NF Consumer Identification | I-TE |
| Charging Identifier | I-TE |
| Invocation Timestamp | I-TE |
| Invocation Sequence Number | I-TE |
| Retransmission Indicator | — |
| One-time Event | ---E |
| One-time Event Type | ---E |
| Notify URI | I--- |
| Supported Features | I--E |
| Triggers | I-TE |
| Multiple Unit Usage | I-TE |

NEF API Charging Information

| | |
|---|---|
| External Individual Identifier | I-TE |
| Internal Individual Identifier | ITE |
| External Group Identifier | I-TE |
| Internal Group Identifier | I-TE |
| List of UEs | I-TE |
| Consolidated Data Rate | I-TE |
| API Direction | I-TE |
| API Target Network Function | I-TE |
| API Result Code | I-TE |
| API Name | I-TE |
| API Operation | ITE |
| API Reference | I-TE |
| API Content | I-TE |

FIG. 3 illustrates an example of a network device 300 according to an embodiment of the present disclosure. The network device 300 is configured to implement some embodiments of the disclosure. Some embodiments of the disclosure may be implemented into the network device 300 using any suitably configured hardware and/or software. The network device 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the memory 301 stores executable instructions that when executed by the processor cause the processor 303 to effectuate operations including: transmitting, by a network exposure function (NEF) to a charging function (CHF), a charging data request message including at least one information element associated with a charging reporting for AI/ML operation and allowing and/or triggering the CHF to identify the at least one information element associated with the charging reporting for AI/ML operation based on the charging data request message.

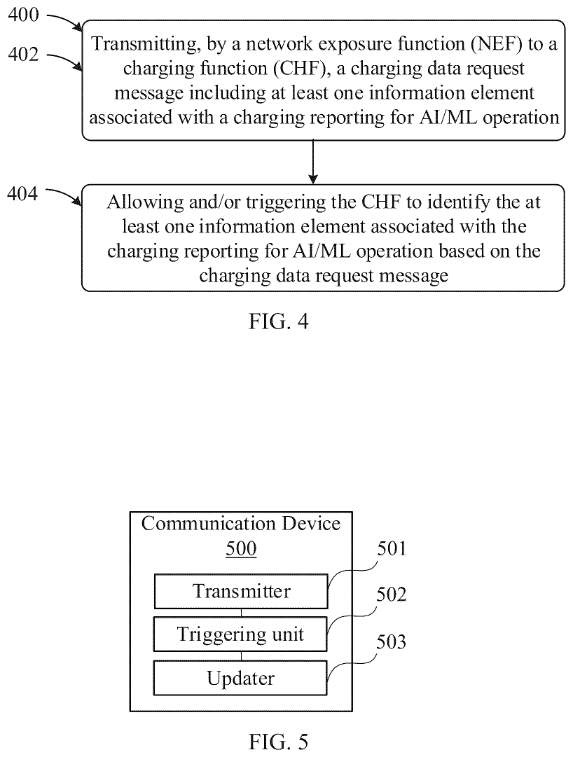

FIG. 4 illustrates a communication method for artificial intelligence (AI)/machine learning (ML) operation according to an embodiment of the present disclosure. FIG. 4 is an example of a communication method 400 for artificial intelligence (AI)/machine learning (ML) operation according to an embodiment of the present disclosure. The communication method 400 for artificial intelligence (AI)/machine learning (ML) operation is configured to implement some embodiments of the disclosure. Some embodiments of the disclosure may be implemented into the communication method 400 for artificial intelligence (AI)/machine learning (ML) operation using any suitably configured hardware and/or software. In some embodiments, the communication method 400 for artificial intelligence (AI)/machine learning (ML) operation includes: an operation 402, transmitting, by a network exposure function (NEF) to a charging function (CHF), a charging data request message including at least one information element associated with a charging reporting for AI/ML operation, and an operation 404, allowing and/or triggering the CHF to identify the at least one information element associated with the charging reporting for AI/ML operation based on the charging data request message.

In some embodiments, the communication method 400 for artificial intelligence (AI)/machine learning (ML) operation further includes an operation, updating, by the NEF, a corresponding operation when the at least one information element associated with the charging reporting for AI/ML operation is changed.

In some embodiments, the at least one information element associated with the charging reporting for AI/ML operation includes at least one trigger and/or an NEF application program interface (API) charging information. In some embodiments, the at least one trigger supports updating a list of user equipments (UEs) and/or updating a consolidated data rate value. In some embodiments, the at least one trigger allows and/or triggers the charging reporting for AI/ML operation from the NEF to the CHF when a change of a list of UEs and/or a consolidated data rate is received in an updated request by the NEF from an application function (AF).

In some embodiments, the at least one trigger holds at least one NEF specific trigger, and the at least one NEF specific trigger includes an API invocation trigger condition in the NEF, an API invocation response trigger condition in the NEF, an API notification trigger condition in the NEF, an API notification to a network function (NF) trigger condition in the NEF, and/or an API notification acknowledgement trigger condition in the NEF. The different scenarios below focus on the different messages from/to the NEF and corresponding interaction with the CHF, based on scenarios

FIG. 5 illustrates a communication device according to an embodiment of the present disclosure. FIG. 5 illustrates that, in some embodiments, a communication device 500 includes a transmitter 501 and a triggering unit 502. The transmitter 501 is configured to transmit to a charging function (CHF), a charging data request message including at least one information element associated with a charging reporting for artificial intelligence (AI)/machine learning (ML) operation. The triggering unit 502 is configured to configured to allow and/or trigger the CHF to identify the at least one information element associated with the charging reporting for AI/ML operation based on the charging data request message.

In some embodiments, the communication device 500 further includes an updater 503 configured to update a corresponding operation when the at least one information element associated with the charging reporting for AI/ML operation is changed. In some embodiments, the at least one information element associated with the charging reporting for AI/ML operation includes at least one trigger and/or a network exposure function (NEF) application program interface (API) charging information. In some embodiments, the at least one trigger supports updating a list of user equipments (UEs) and/or updating a consolidated data rate value. In some embodiments, the at least one trigger allows and/or triggers the charging reporting for AI/ML operation from the triggering unit 502 to the CHF when a change of a list of UEs and/or a consolidated data rate is received in an updated request by the transmitter 501 from an application function (AF).

In some embodiments, the at least one trigger holds at least one NEF specific trigger, and the at least one NEF specific trigger includes an API invocation trigger condition in the communication device, an API invocation response trigger condition in the communication device, an API notification trigger condition in the communication device, an API notification to a network function (NF) trigger condition in the communication device 500, and/or an API notification acknowledgement trigger condition in the communication device. In some embodiments, a structure of the NEF API charging information includes a list of UEs and/or a consolidated data rate. In some embodiments, the NEF API charging information is transferred within a charging data request by the communication device 500 to the CHF and allows the CHF to identify the list of Ues and/or the consolidated data rate. In some embodiments, the list of UEs hold a list of generic public subscription identifiers (GPSIs) or subscriber permanent identifiers (SUPIs) for reported UEs.

In some embodiments, the consolidated data rate indicates an upper bound of an aggregated data rate across all traffic flows corresponding to the list of UEs. In some embodiments, at least one supported field in the charging data request message includes a list of UEs and/or a consolidated data rate. In some embodiments, at least one supported operation type of the list of UEs and/or the consolidated data rate by the communication device includes an initial operation type, a termination operation type, and/or an event operation type. In some embodiments, the communication device includes an NEF.

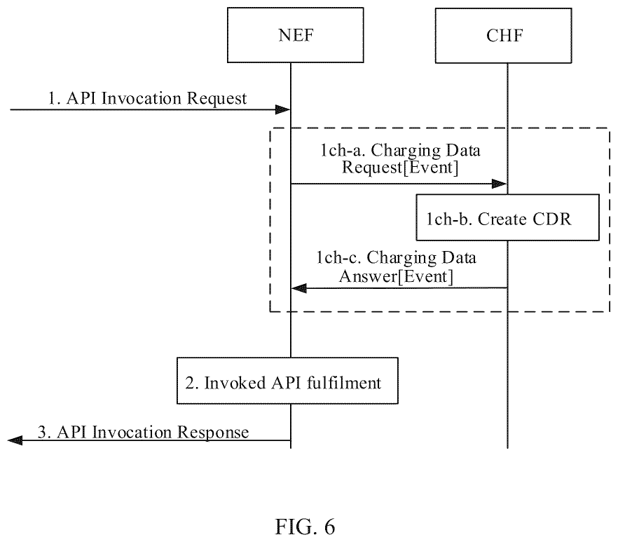

FIG. 6 to FIG. 11 provide some examples regarding the at least one NEF specific trigger, an API invocation trigger condition in the NEF, an API invocation response trigger condition in the NEF, an API notification trigger condition in the NEF, an API notification to a network function (NF) trigger condition in the NEF, and an API notification acknowledgement trigger condition in the NEF as illustrated in Table: Trigger conditions in NEF.

TABLE
Trigger conditions in NEF

| | | | CHF | CHF | Message when |
|---|---|---|---|---|---|
| | | | allowed to | allowed to | “immediate |
| Trigger | Trigger | Default | change | enable and | reporting” |
| Conditions | level | category | category | disable | category |
| API Invocation | — | Immediate | Not | Not | IEC: Charging Data |
| | | | Applicable | Applicable | Request [Event] |
| | | | | | ECUR: Charging |
| | | | | | Data Request |
| | | | | | [Initial] |
| API Invocation | — | Immediate | Not | Not | PEC: Charging Data |
| Response | | | Applicable | Applicable | Request [Event] |
| | | | | | ECUR: Charging |
| | | | | | Data Request |
| | | | | | [Termination] |
| API Notification | — | Immediate | Not | Not | IEC: Charging Data |
| | | | Applicable | Applicable | Request [Event] |
| | | | | | ECUR: Charging |
| | | | | | Data Request |
| | | | | | [Initial] |
| API Notification | — | Immediate | Not | Not | PEC: Charging Data |
| to NF | | | Applicable | Applicable | Request [Event] |
| API Notification | — | Immediate | Not | Not | ECUR: Charging |
| acknowledgement | | | Applicable | Applicable | Data Request |
| | | | | | [Termination] |

FIG. 6 illustrates an API Invocation Request to NEF using IEC configured to implement some embodiments presented herein. FIG. 6 describes the scenario where there is an API invocation request at the NEF for IEC mode. In operations, 1.NEF receives an API invocation Request from an AF. 1ch-a. The NEF sends Charging Data Request [Event] to CHF for the received API Invocation. 1ch-b. The CHF creates a CDR for this API Invocation. 1ch-c. The CHF acknowledges and grants authorization by sending Charging Data Response [Event] to the NEF. 2.NEF performs the actions needed to fulfil the API invoked. 3. If authorized, the NEF continues the API invocation processing and sends the API Invocation Response.

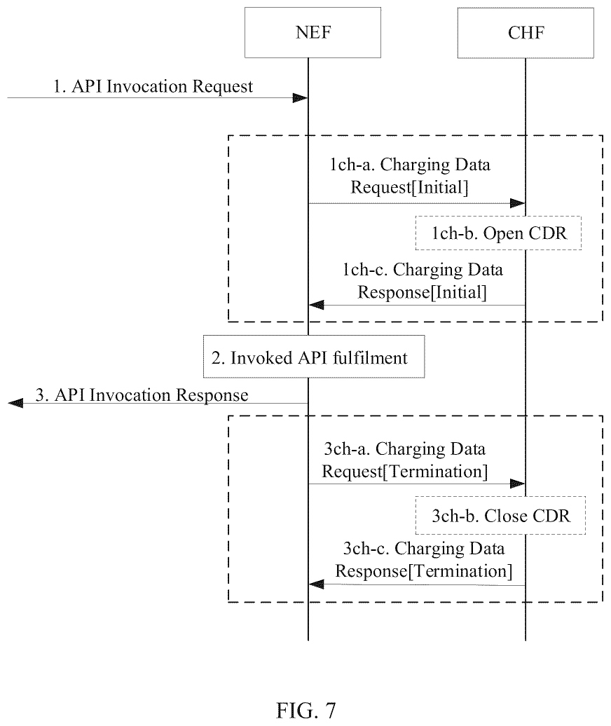

FIG. 7 illustrates an API Invocation Request to NEF using ECUR configured to implement some embodiments presented herein. FIG. 7 describes the scenario where there is an API invocation request at the NEF for ECUR mode. In operations, 1. NEF receives an API invocation Request from an AF. 1ch-a. The NEF sends Charging Data Request [Initial] to CHF for the received API Invocation. 1ch-b. The CHF opens CDR for this API Invocation. 1ch-c. The CHF acknowledges by sending Charging Data Response [Initial] to the NEF. 2.NEF performs the actions needed to fulfil the API invoked. 3.If authorized, the NEF continues the API invocation processing and sends the API Invocation Response. 3ch-a. The NEF sends Charging Data Request [Termination] to the CHF for terminating the charging associated with the API Invocation. 3ch-b. The CHF closes the CDR for this API Invocation. 3ch-c. The CHF acknowledges by sending Charging Data Response [Termination] to the NEF.

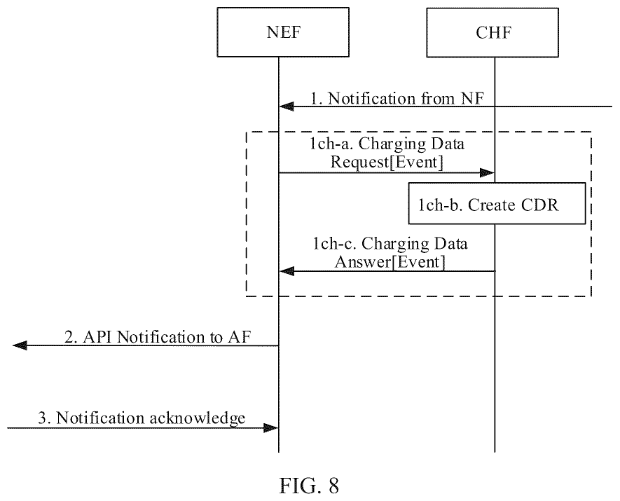

FIG. 8 illustrates an API Notification from NEF using IEC configured to implement some embodiments presented herein. FIG. 8 describes the scenario where an API Notification is delivered from the NEF for IEC mode. In operations, 1. The NEF receives a notification from an NF. 1ch-a. The NEF sends Charging Data Request [Event] to CHF for the Notification. 1ch-b. The CHF creates a CDR for this Notification. 1ch-c. The CHF acknowledges and grant authorization by sending Charging Data Response [Event] to the NEF. 2. The NEF sends the notification to AF. 3. The NEF receives acknowledgement for the notification.

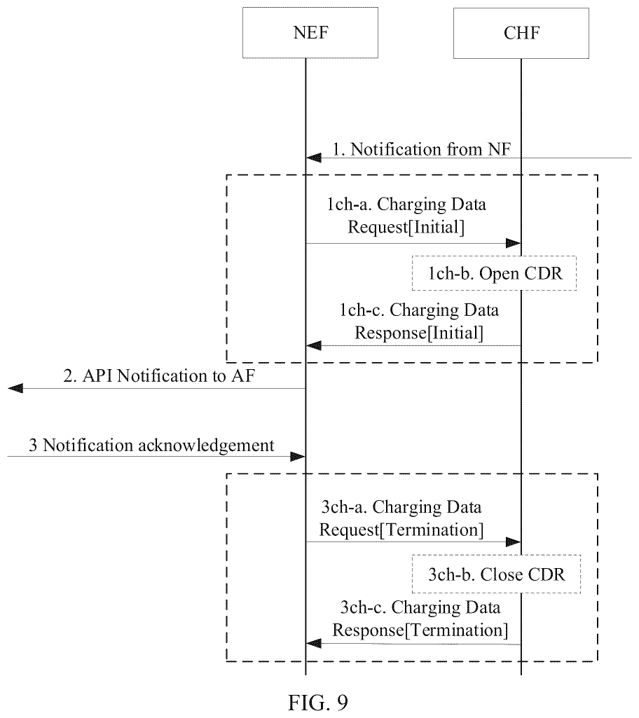

FIG. 9 illustrates an API Notification from NEF using ECUR configured to implement some embodiments presented herein. FIG. 9 describes the scenario where an API event Notification is delivered from the NEF for ECUR mode. In operations, 1. The NEF receives a notification from an NF. 1ch-a. The NEF sends Charging Data Request [Initial] to CHF for the Notification. 1ch-b. The CHF opens CDR for this API Notification. 1ch-c. The CHF acknowledges by sending Charging Data Response [Initial] to the NEF. 2. The NEF sends the notification to AF. 3. The NEF receives acknowledgement for the notification. 3ch-a. The NEF sends Charging Data Request [Termination] to the CHF for terminating the charging associated with the API event Notification. 3ch-b. The CHF closes the CDR for this API Notification. 3ch-c. The CHF acknowledges by sending Charging Data Response [Termination] to the NEF.

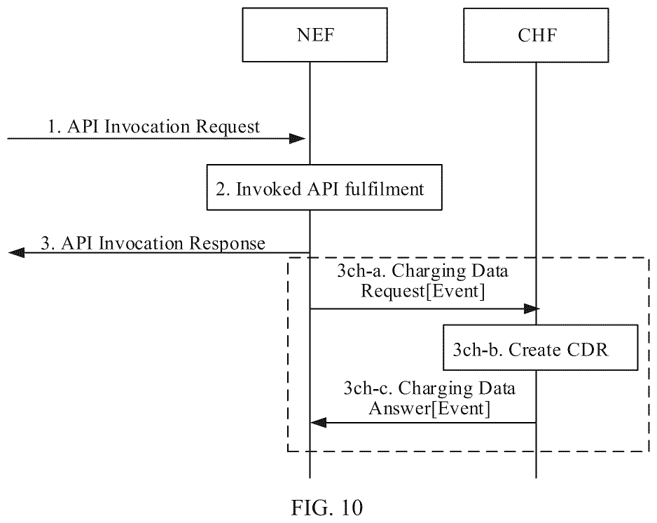

FIG. 10 illustrates an API Invocation Request to NEF using PEC configured to implement some embodiments presented herein. FIG. 10 describes the scenario where there is an API invocation request at the NEF for PEC mode. In operations, 1.NEF receives an API invocation Request from an AF. 2. NEF performs the actions needed to fulfil the API invoked. 3.If authorized, the NEF continues the API invocation processing and sends the API Invocation Response. 3ch-a. The NEF sends Charging Data Request [Event] to CHF for the received API Invocation. 3ch-b. The CHF creates a CDR for this API Invocation. 3ch-c. The CHF acknowledges by sending Charging Data Response [Event] to the NEF.

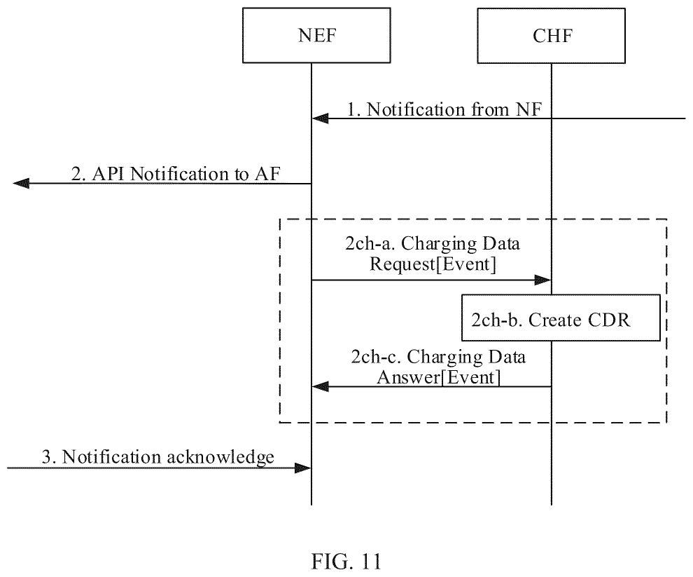

FIG. 11 illustrates an API Notification from NEF using PEC configured to implement some embodiments presented herein. FIG. 11 describes the scenario where an API Notification is delivered from the NEF for PEC mode. 1. The NEF receives a notification from an NF. 2. The NEF sends the notification to AF. 2ch-a. The NEF sends Charging Data Request [Event] to CHF for the Notification. 2ch-b. The CHF creates a CDR for this Notification. 2ch-c. The CHF acknowledges by sending Charging Data Response [Event] to the NEF. 3. The NEF receives acknowledgement for the notification.

In some embodiments, a structure of the NEF API charging information includes a list of UEs and/or a consolidated data rate. In some embodiments, the NEF API charging information is transferred within a charging data request by the NEF to the CHF and allows the CHF to identify the list of UEs and/or the consolidated data rate. In some embodiments, the list of UEs hold a list of generic public subscription identifiers (GPSIs) or subscriber permanent identifiers (SUPIs) for reported UEs. In some embodiments, consolidated data rate indicates an upper bound of an aggregated data rate across all traffic flows corresponding to the list of UEs. In some embodiments, at least one supported field in the charging data request message includes a list of UEs and/or a consolidated data rate. In some embodiments, at least one supported operation type of the list of UEs and/or the consolidated data rate by the NEF includes an initial operation type, a termination operation type, and/or an event operation type.

When feature is introduced into 5GC, Service Providers are looking for a ways to monetize it. Services monetization is is typically based on the reports received by the charging function (CHF) from the core network. This methods proposes standardization mechanisms which would enable monetization strategy (e.g. between the Service Provider and the provider of AI/ML services, or, between the Service Provider and end-devices (UEs) owners) for AI/ML services. Note: Monetization strategy is not necessarily about corresponding direct billing, it may also be about gathering network statistics and then. e.g. proposing new billing mechanisms between the SP and AI/ML Services Provider or between the Service Providers and end-users.

Commercial interests for some embodiments are as follows. 1. Solve issues in the prior art. 2. Provide NEF charging reporting support for the newly suggested parameters related to AI/ML operation. 3. The key aspect of the innovation is introduction of new reporting parameters (list of (affected/requested) UEs and Consolidated Data Rate), provided from NEF to CHF in the charging request, and updating of the operation in case either list of UEs changes or Consolidated data rate gets exceeded. This allows Charging Function to be aware of the AI/ML operation and support billing, credit control, statistics etc. in the Billing Domain for the purposes of appropriate engagement between the Service Provider and the provider of AI/ML Service and/or end-users. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, a network device, and/or a communication system. Compatible products follow at least one proposed solution, method, system, and apparatus of some embodiments of the present disclosure. The proposed solution, method, system, and apparatus are widely used in a UE, a base station, a network device, and/or a communication system. With the implementation of the at least one proposed solution, method, system, and apparatus of some embodiments of the present disclosure, at least one modification/improvement to methods and apparatus of charging reporting for AI/ML operation are considered for standardizing.

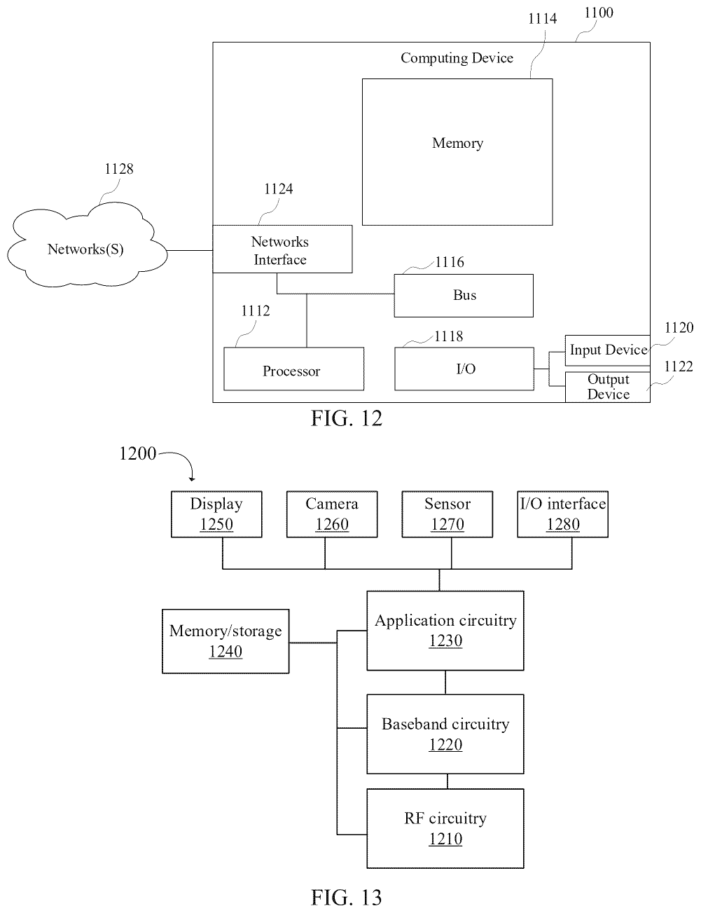

FIG. 12 is an example of a computing device 1100 according to an embodiment of the present disclosure. Any suitable computing device can be used for performing the operations described herein. For example, FIG. 12 illustrates an example of the computing device 1100 that can implement apparatus and/or methods illustrated in FIG. 1 to FIG. 11 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments illustrated in FIG. 1 to FIG. 11. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 13 is a block diagram of an example of a communication system 1200 according to an embodiment of the present disclosure. Embodiments described herein may be implemented into the communication system 1200 using any suitably configured hardware and/or software. FIG. 13 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to FIG. 1 to FIG. 11. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to apparatuses and/or methods illustrated in FIG. 1 to FIG. 11 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an Ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A communication method for artificial intelligence (AI)/machine learning (ML) operation, comprising:
transmitting, by a network exposure function (NEF) to a charging function (CHF), a charging data request message comprising at least one information element associated with a charging reporting for AI/ML operation; and
allowing and/or triggering the CHF to identify the at least one information element associated with the charging reporting for AI/ML operation based on the charging data request message.

2. The method of claim 1, further comprising updating, by the NEF, a corresponding operation when the at least one information element associated with the charging reporting for AI/ML operation is changed.

3. The method of claim 1, wherein the at least one information element associated with the charging reporting for AI/ML operation comprises at least one trigger and/or an NEF application program interface (API) charging information.

4. The method of claim 3, wherein the at least one trigger supports updating a list of user equipments (UEs) and/or updating a consolidated data rate value;
wherein the at least one trigger allows and/or triggers the charging reporting for AI/ML operation from the NEF to the CHF when a change of a list of UEs and/or a consolidated data rate is received in an updated request by the NEF from an application function (AF).

5. The method of claim 3, wherein the at least one trigger holds at least one NEF specific trigger, and the at least one NEF specific trigger comprises an API invocation trigger condition in the NEF, an API invocation response trigger condition in the NEF, an API notification trigger condition in the NEF, an API notification to a network function (NF) trigger condition in the NEF, and/or an API notification acknowledgement trigger condition in the NEF.

6. The method of claim 3, wherein a structure of the NEF API charging information comprises a list of UEs and/or a consolidated data rate;
wherein the NEF API charging information is transferred within a charging data request by the NEF to the CHF and allows the CHF to identify the list of UEs and/or the consolidated data rate.

7. The method of claim 6, wherein the list of UEs hold a list of generic public subscription identifiers (GPSIs) or subscriber permanent identifiers (SUPIs) for reported UEs.

8. The method of claim 6, wherein the consolidated data rate indicates an upper bound of an aggregated data rate across all traffic flows corresponding to the list of UEs.

9. The method of claim 1, wherein at least one supported field in the charging data request message comprises a list of UEs and/or a consolidated data rate;
wherein at least one supported operation type of the list of UEs and/or the consolidated data rate by the NEF comprises an initial operation type, a termination operation type, and/or an event operation type.

10. A communication device, comprising:
a transmitter configured to transmit to a charging function (CHF), a charging data request message comprising at least one information element associated with a charging reporting for artificial intelligence (AI)/machine learning (ML) operation; and
a triggering unit configured to allow and/or trigger the CHF to identify the at least one information element associated with the charging reporting for AI/ML operation based on the charging data request message.

11. The communication device of claim 10, further comprising an updater configured to update a corresponding operation when the at least one information element associated with the charging reporting for AI/ML operation is changed.

12. The communication device of claim 10, wherein the at least one information element associated with the charging reporting for AI/ML operation comprises at least one trigger and/or a network exposure function (NEF) application program interface (API) charging information.

13. The communication device of claim 12, wherein the at least one trigger supports updating a list of user equipments (UEs) and/or updating a consolidated data rate value;
wherein the at least one trigger allows and/or triggers the charging reporting for AI/ML operation from the triggering unit to the CHF when a change of a list of UEs and/or a consolidated data rate is received in an updated request by the transmitter from an application function (AF).

14. The communication device of claim 12, wherein the at least one trigger holds at least one NEF specific trigger, and the at least one NEF specific trigger comprises an API invocation trigger condition in the communication device, an API invocation response trigger condition in the communication device, an API notification trigger condition in the communication device, an API notification to a network function (NF) trigger condition in the communication device, and/or an API notification acknowledgement trigger condition in the communication device.

15. The communication device of claim 12, wherein a structure of the NEF API charging information comprises a list of UEs and/or a consolidated data rate;
wherein the NEF API charging information is transferred within a charging data request by the communication device to the CHF and allows the CHF to identify the list of UEs and/or the consolidated data rate.

16. The communication device of claim 15, wherein the list of UEs hold a list of generic public subscription identifiers (GPSIs) or subscriber permanent identifiers (SUPIs) for reported UEs.

17. The communication device of claim 15, wherein the consolidated data rate indicates an upper bound of an aggregated data rate across all traffic flows corresponding to the list of UEs.

18. The communication device of claim 10, wherein at least one supported field in the charging data request message comprises a list of UEs and/or a consolidated data rate.

19. The communication device of claim 18, wherein at least one supported operation type of the list of UEs and/or the consolidated data rate by the communication device comprises an initial operation type, a termination operation type, and/or an event operation type.

20. The communication device of 10, wherein the communication device comprises an NEF.
